(19) United States
(12) Patent Application Publication
(10) Pub. No.: US 2017/0014939 A1
(43) Pub. Date: Jan. 19, 2017

(54) WORKPIECE SECURING DEVICE FOR FRICTION STIR WELDING DEVICE

(71) Applicant: IHI Corporation, Tokyo (JP)

(72) Inventors: Hiroshi SAITO, Tokyo (JP); Naoki OIWA, Tokyo (JP); Hisashi MATSUOKA, Tokyo (JP); Satoshi YAMANAKA, Tokyo (JP); Yasushi TABEI, Tokyo (JP)

(73) Assignee: IHI Corporation, Tokyo (JP)

(21) Appl. No.: 15/278,260

(22) Filed: Sep. 28, 2016

Related U.S. Application Data
(63) Continuation of application No. PCT/JP2015/060460, filed on Apr. 2, 2015.

(30) Foreign Application Priority Data
Apr. 2, 2014 (JP) 2014-076084

(51) Int. Cl. B23K 20/12; B23K 37/04

(52) U.S. Cl. CPC B23K 20/126; B23K 37/0408

(57) ABSTRACT

A workpiece securing device or a friction stir welding device is constituted of a starting-end-side workpiece stopper that positions a welding starting-end-side end of a workpiece to be placed on a workpiece surface plate; a finishing-end-side workpiece stopper that positions a welding finishing-end-side end of the workpiece; a starting-end-side workpiece clamping mechanism that presses and secures a portion along a welding line close to the welding starting-end-side end of the workpiece against the workpiece surface plate from above; and a finishing-end-side workpiece clamping mechanism that presses and secures a portion along the welding line close to the welding finishing-end-side end of the workpiece against the workpiece surface plate from above. In a state where the welding starting-end-side end and the welding finishing-end-side end of the workpiece placed on the workpiece surface plate are positioned, only the portions along the welding line close to the welding starting-end-side end and close to the welding finishing-end-side end of the workpiece are secured.

This application is a Continuation of International Application No. PCT/JP2015/060460, filed on Apr. 2, 2015, claiming priority based on Japanese Patent Application No. 2014-076084, filed on Apr. 2, 2014, the contents of which are incorporated herein by reference in their entirety.

### TECHNICAL FIELD

Embodiments described herein relates to a workpiece securing device for a friction stir welding device that is used to secure the position of a workpiece placed on a workpiece surface plate of the friction stir welding device.

### BACKGROUND

Friction stir welding devices use a technique of pressing a probe (also referred to as a pin) of a friction stir welding tool against a welded part in which workpieces are butted against each other in a rotated state, sinking this rotating probe into the workpieces, and moving the probe over the entire length of a welding line. Accordingly, the workpieces are integrally welded together by, in friction stir welding, generating frictional heat caused by contact with the rotating probe in the welded part of the workpieces to soften the periphery of the welded part, and stirring and mixing the periphery of this softened welded part through plastic flow with the rotation of the probe (for example, refer to Patent Document 1).

In recent years, this friction stir welding is actually applied to, for example, mainly welding of thin plate-shaped aluminum workpieces.

When friction stir welding is executed, a large pressing force in a direction (hereinafter referred to as a friction stir welding traveling direction) in which the friction stir welding travels along the welding line acts on a workpiece with the movement of the probe of the friction stir welding tool. Moreover, a force pulling apart the welded parts and a force rotating the probe in its rotational direction also act on the portion of the workpiece through which the probe of the friction stir welding tool passes.

Therefore, in the friction stir welding device, it may be necessary to secure each workpiece on a workpiece surface plate such that positional deviation does not occur even if the workpiece receives the above force.

As workpiece securing method for the friction stir welding device, it is known that a starting-end-side end for friction stir welding in the workpiece and a finishing-end-side end for friction stir welding in the workpiece is bumped and secured against a securing block provided on an upper surface of the workpiece surface plate.

Moreover, in a case where the dimension of the workpiece in a direction (hereinafter referred to as a width direction) orthogonal to the friction stir welding traveling direction is smaller than the dimension of the workpiece surface plate in the width direction, both the outer sides of the workpiece in the width direction are also secured to the workpiece surface plate with the securing block.

On the other hand, as workpiece securing method in a case where the dimension of the workpiece in the width direction is greater than the dimension of the workpiece surface plate in the width direction, a technique of securing the workpiece to an end of the workpiece surface plate with a clamping device, and a technique of securing the ends of the workpiece in the width direction to separate supporting bases provided on both the outer sides of the workpiece surface plate in the width direction, using the securing block and a clamping device capable of adjusting the width thereof, may be adopted (for example, see Patent Document 2).

Moreover, in a case where workpieces that are elongated in the friction stir welding traveling direction are welded together, in order to prevent lifting or deviation caused by the buckling of the workpieces, weights of hundreds of kilograms may be placed at positions close to the welding line between the workpieces.

Therefore, in the related art, in a case where large-sized workpieces with large width dimensions and large dimensions in the friction stir welding traveling direction are used as objects to be welded, much time and effort are required for setup before the friction stir welding for securing the workpieces to workpiece surface plates.

### CITATION LIST

### Patent Document

[Patent Document 1] PCT International Publication No. 12/060439

[Patent Document 2] Japanese Unexamined Patent Application, First Publication No. 2001-205453

### SUMMARY

### Technical Problem

The present disclosure is made in view of the above-described circumstances, and an object thereof is to provide a workpiece securing device for a friction stir welding device that can easily secure even a large-sized workpiece to a workpiece surface plate.

### Solution to Problem

A first aspect of the present disclosure is a workpiece securing device for a friction stir welding device which includes a workpiece surface plate on which each of workpieces serving as objects to be welded is to be placed in a state where the workpieces are butted against each other; a starting-end-side workpiece stopper that positions a welding starting-end-side end where friction stir welding of each workpiece is started, at an upstream end of the workpiece surface plate in a friction stir welding traveling direction; a starting-end-side workpiece clamping mechanism that presses and secures a portion along a welding line between the workpieces close to the welding starting-end-side end of each workpiece against the workpiece surface plate from above; a finishing-end-side workpiece stopper that positions a welding finishing-end-side end where the friction stir welding of each workpiece ends, on a downstream side of the workpiece surface plate in the friction stir welding traveling direction; and a finishing-end-side workpiece clamping mechanism that presses and secures a portion along the welding line between the workpieces close to the welding finishing-end-side end of each workpiece against the workpiece surface plate from above.

In a second aspect of the present disclosure, the finishing-end-side workpiece stopper is detachably attached to the workpiece surface plate such that the position thereof is changeable in an upstream-downstream direction in the friction stir welding traveling direction.

In a third aspect of the present disclosure, the finishing-end-side workpiece stopper includes a workpiece pressing member to be pressed against the welding finishing-end-side end of the workpiece such that the position of the workpiece pressing member is changeable in an upstream-downstream direction in the friction stir welding traveling direction.

In a fourth aspect of the present disclosure, the starting-end-side workpiece clamping mechanism is switchable between a state where the starting-end-side workpiece clamping mechanism is disposed at a position above the portion along the welding line between the workpieces close to the welding starting-end-side end of the workpiece placed on the workpiece surface plate, and a state where the starting-end-side workpiece clamping mechanism is withdrawn from a position above the workpiece.

In a fifth aspect of the present disclosure, the finishing-end-side workpiece clamping mechanism is switchable between a state where the finishing-end-side workpiece clamping mechanism is disposed at a position above the portion along the welding line between the workpieces close to the welding finishing-end-side end of the workpiece placed on the workpiece surface plate, and a state where the finishing-end-side workpiece clamping mechanism is withdrawn from a position above the workpiece.

In a sixth aspect of the present disclosure, the welding finishing-end-side workpiece clamping mechanism is movable with respect to the workpiece surface plate in an upstream-downstream direction in the friction stir welding traveling direction.

A seventh aspect of the present disclosure is a method of securing a workpiece for a friction stir welding device includes positioning a first workpiece of a pair of workpieces, on a first workpiece surface plate of a pair of workpiece surface plates facing each other with a gap therebetween, in an upstream-downstream direction in a friction stir welding traveling direction and in a width direction of the workpiece surface plate; pressing and securing a portion close to a welding starting-end-side end of the first workpiece and in the vicinity of the gap against the first workpiece surface plate from above; positioning a second workpiece of the pair of workpieces on a second workpiece surface plate of the pair of workpiece surface plates, in the upstream-downstream direction in the friction stir welding traveling direction and in the width direction of the first workpiece surface plate; pressing and securing a portion close to the welding starting-end-side end of the second workpiece and in the vicinity of the gap against the second workpiece surface plate from above; and pressing and securing portions close to the welding finishing-end-side ends of the pair of workpieces and in the vicinity of the gap against the pair of workpiece surface plates from above.

According to the present disclosure, the following excellent effects are exhibited.

The welding starting-end-side end and the welding finishing-end-side end of each workpiece placed on each workpiece surface plate just have to be respectively positioned on the upper side of the workpiece surface plate by the starting-end-side workpiece stopper and the finishing-end-side workpiece stopper, and in that state, only the portion along the welding line close to the welding starting-end-side end and the portion along the welding line close to the welding finishing-end-side end just have to be secured by the starting-end-side workpiece clamping mechanism and the finishing-end-side workpiece clamping mechanism. Therefore, since separate workpiece securing member that performs securing between the starting-end-side workpiece clamping mechanism and the finishing-end-side workpiece clamping mechanism or securing member that secures each workpiece from the outside in the width direction is unnecessary, even a large-sized workpiece can be easily secured to each workpiece surface plate.

### BRIEF DESCRIPTION OF DRAWINGS

FIG. 1 is a schematic plan view showing an embodiment of a workpiece securing device for a friction stir welding device of the present disclosure.

FIG. 2 is an enlarged view of a friction stir welding device to which the workpiece securing device of the present disclosure of FIG. 1 is applied, as seen from a downstream side in a friction stir welding traveling direction.

FIG. 3A is an enlarged plan view showing starting-end-side workpiece stoppers and starting-end-side workpiece clamping mechanisms in the workpiece securing device of the present disclosure of FIG. 1.

FIG. 3B is an enlarged side view showing the starting-end-side workpiece stoppers and the starting-end-side workpiece clamping mechanisms in the workpiece securing device of the present disclosure of FIG. 1.

FIG. 4A is an enlarged plan view showing finishing-end-side workpiece stoppers in the workpiece securing device of the present disclosure of FIG. 1.

FIG. 4B is an enlarged cut side view showing the finishing-end-side workpiece stoppers in the workpiece securing device of the present disclosure of FIG. 1.

FIG. 5A is an enlarged plan view showing a finishing-end-side workpiece clamping mechanism in the workpiece securing device of the present disclosure of FIG. 1.

FIG. 5B is an enlarged side view showing the finishing-end-side workpiece clamping mechanism in the workpiece securing device of the present disclosure of FIG. 1.

FIG. 6 is a schematic perspective view of a workpiece positioning jig used when placing a workpiece on a first workpiece surface plate of the friction stir welding device.

### DESCRIPTION OF EMBODIMENTS

Hereinafter, embodiments of the present disclosure will be described with reference to the drawings.

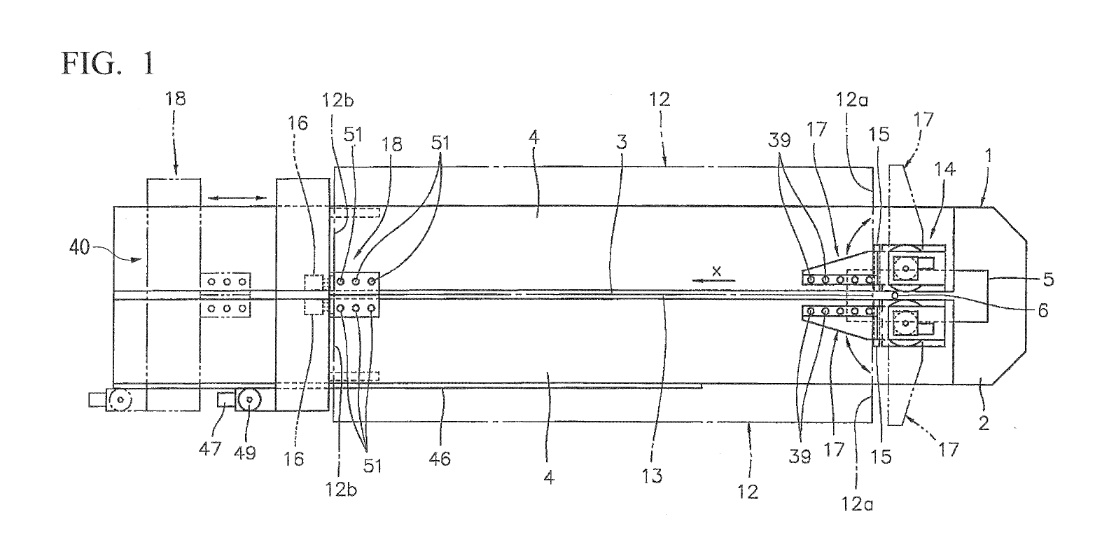

FIGS. 1 to 6 show an embodiment of a workpiece securing device for a friction stir welding device of the present disclosure.

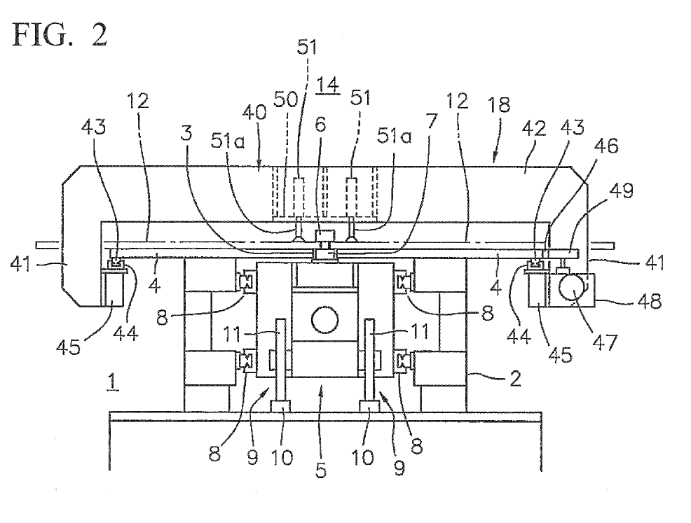

The workpiece securing device for a friction stir welding device of the present disclosure (hereinafter abbreviated as a workpiece securing device of the present disclosure) is applied to, for example, a friction stir welding device 1 as shown in FIGS. 1 and 2.

Similar to the friction stir welding device described in Patent Document 1, the friction stir welding device 1 to which the workpiece securing device of the present disclosure is applied is constituted of a welding device body 5 equipped with a frame 2 that is longer than the length of a welding line 13 along which two workpieces 12 are welded together, a pair of workpiece surface plates 4 that is installed on an upper side of the frame 2 so as to form a gap 3 extending along the welding line 13 between the workpieces 12, a friction stir welding tool 6 that is located below the gap 3 and protrude upward from the gap 3, a main shaft 7 that has the friction stir welding tool 6 attached to an upper end thereof, and a drive device (not illustrated) that drives the main shaft 7; a linear guide mechanism 8 that supports the welding device body 5 so as to be movable along the gap 3; and a moving device 9 that moves the welding device body 5 along the gap 3.

In addition, the moving device 9 is of a rack-and-pinion type including a rack (pin rack) 10 installed parallel to the gap 3 at an inner bottom part of the frame 2 and a pinion (pin gear) 11 rotatably provided in the welding device body 5.

In the friction stir welding device 1, a direction of an arrow x in FIG. 1 in which the friction stir welding tool 6 is moved integrally with the welding device body 5 from one end side of the welding line 13 between the workpieces 12 to the other end side thereof becomes a friction stir welding traveling direction. As a result, an upstream end of each workpiece 12 in the friction stir welding traveling direction is referred to as a welding starting-end-side end 12a, and a downstream end of the workpiece 12 in the friction stir welding traveling direction is referred to as a welding finishing-end-side end 12b.

The workpiece securing device 14 of the present disclosure applied to the friction stir welding device 1 having the above configuration is constituted of starting-end-side workpiece stoppers 15, finishing-end-side workpiece stoppers 16, starting-end-side workpiece clamping mechanisms 17, and a finishing-end-side workpiece clamping mechanism 18, which are provided in each workpiece surface plate 4.

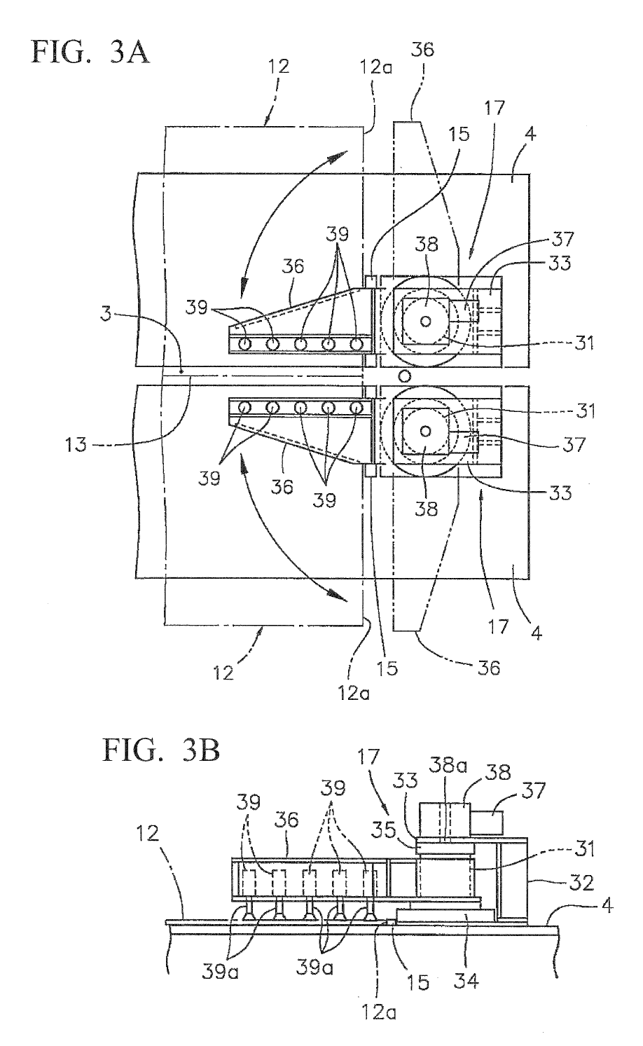

As shown in FIGS. 3A and 3B, the starting-end-side workpiece stoppers 15 are rectangular parallelepiped-shaped members that position the welding starting-end-side ends 12a of the workpieces 12 and extend in a width direction of the workpiece surface plates 4, and are symmetrically disposed in a direction orthogonal to the welding line 13 with the gap 3 being interposed therebetween, at upstream ends of upper surfaces of the pair of workpiece surface plates 4 in the friction stir welding traveling direction. Accordingly, the welding starting-end-side ends 12a are positioned by abutting the respective welding starting-end-side ends 12a of the pair of workpieces 12 placed on the pair of workpiece surface plates 4 on the corresponding starting-end-side workpiece stoppers 15 disposed on the workpiece surface plates 4.

The finishing-end-side workpiece stoppers 16 are attached to the upper surfaces of the pair of workpiece surface plates 4, are used for positioning the welding finishing-end-side ends 12b of the respective workpieces 12 placed on the respective workpiece surface plates 4, and are movable in a direction along the friction stir welding traveling direction of the workpieces 12. Therefore, even if the dimensions of the workpieces 12 along the welding line 13 are different from each other, the workpiece can be disposed such that the respective welding finishing-end-side ends 12b of the workpieces 12 abut against the finishing-end-side workpiece stoppers 16.

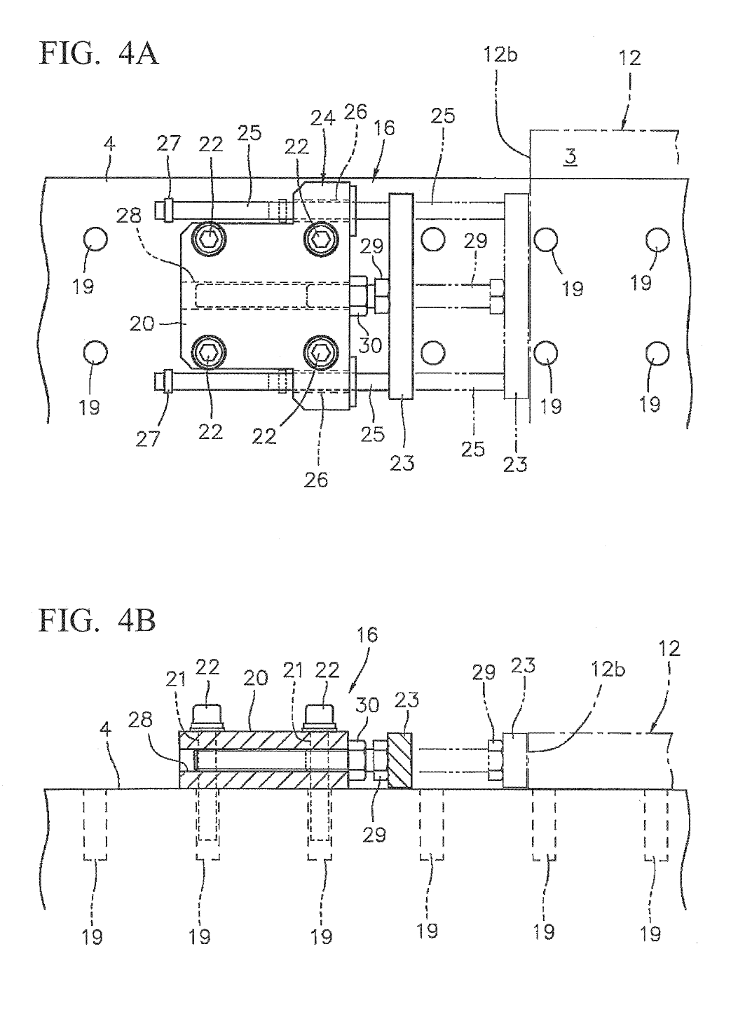

Therefore, as shown in FIGS. 4A and 4B, a plurality of tap holes (screw holes) 19 are provided in an arrangement of a regular pitch, for example, 100 mm pitch with a certain dimension along the friction stir welding traveling direction in advance in a region along the gap 3 on the surface of each workpiece surface plate 4. A configuration in which the tap holes 19 arranged at a regular pitch in the friction stir welding traveling direction are provided in two rows in the width direction of the workpiece surface plate 4 is shown in FIG. 4A.

Each finishing-end-side workpiece stopper 16 includes a block member 20 provided with a plurality of bolt insertion holes 21 that penetrate in an upward-downward direction so as to correspond the arrangement pitch of the tap holes 19 along the gap 3 between the workpiece surface plates 4, a workpiece pressing member 23, and positional adjustment member 24 that protrudes the workpiece pressing member 23 from the block member 20 to the upstream side in the friction stir welding traveling direction and adjusts the amount of protrusion. The block member 20 can arbitrarily change the attachment position of the block member 20 to each workpiece surface plate 4 in an upstream-downstream direction in the friction stir welding traveling direction by attaching bolts 22 such that the bolt insertion hole 21 are made to correspond to the arbitrary tap holes 19 of the workpiece surface plate 4.

The workpiece pressing member 23 is a rectangular parallelepiped-shaped member that extends in the width direction of the workpiece surface plate 4, and is disposed on the upstream side in the friction stir welding traveling direction of the block member 20.

One longitudinal end of a guide rod 25 that extends parallel to the friction stir welding traveling direction is attached to a surface on a downstream side in the friction stir welding traveling direction in each of a plurality of locations in a longitudinal direction of the workpiece pressing member 23. Guide holes 26 that penetrates along the friction stir welding traveling direction are drilled in a plurality of locations in the width direction orthogonal to the friction stir welding traveling direction in the block member 20. The corresponding guide rods 25 are slidably inserted into the respective guide holes 26, and the workpiece pressing member 23 can be displaced relative to the block member 20 via the guide rods 25 and the guide holes 26. A retaining stopper 27 having a larger outside dimension than the diameter of each guide hole 26 is attached to the other longitudinal end of each guide rod 25. Accordingly, the workpiece pressing member 23 is held by the block member 20 so as to be movable in the upstream-downstream direction in the friction stir welding traveling direction via the guide rods 25 and the guide holes 26.

In order to adjust the position of the workpiece pressing member 23, the positional adjustment member 24 has, for example, a configuration in which a tap hole 28 extending in a direction along the friction stir welding traveling direction is provided at a position between the respective guide holes 26 of the block member 20, and a bolt 29 in a state where a locking nut 30 is threadedly engaged with a shaft part thereof in advance is screwed into the tap hole 28 from the upstream side in the friction stir welding traveling direction. Therefore, the workpiece pressing member 23 abuts against a head part of the bolt 29.

Accordingly, in the positional adjustment member 24 of the above configuration, the workpiece pressing member 23 can be disposed closest to the block member 20 by bringing about a state where the bolt 29 is most deeply screwed into the tap hole 28 of the block member 20 and bringing the workpiece pressing member 23 into contact with the head part of the bolt 29. On the other hand, if the bolt 29 is rotationally operated in a direction in which the bolt is loosened from this state, the bolt 29 protrudes gradually from the tap hole 28. Therefore, the workpiece pressing member 23 is pushed and displaced to the upstream side in the friction stir welding traveling direction by the head part of the bolt 29. Therefore, the amount of protrusion of the workpiece pressing member 23 from the block member 20 is adjusted steplessly. Since the bolt 29 is secured by fastening the locking nut 30 threadedly engaged with bolt 29 into the bolt 29 in a state where the locking nut 30 is made to abut against the block member 20 after the amount of protrusion of the workpiece pressing member 23 from the block member 20 is adjusted, the workpiece pressing member 23 is prevented from being displaced in a direction in which the workpiece pressing member 23 approaches the block member 20.

The adjustable range of the amount of protrusion of the workpiece pressing member 23 from the block member 20 by the positional adjustment member 24 is set to a dimension equal to or more than the arrangement pitch of the tap holes 19 that is a change unit of the attachment position of the block member 20 to the aforementioned individual workpiece surface plate 4. For example, in a case where the arrangement pitch of the tap holes 19 in the workpiece surface plate 4 is 100 mm, the adjustable range of the amount of protrusion by the positional adjustment member 24 is set to about 105 mm.

Accordingly, even if the welding finishing-end-side end 12b of the workpiece 12 placed on the workpiece surface plate 4 is located at any position, the finishing-end-side workpiece stopper 16 can be disposed such that the workpiece pressing member 23 is reliably pressed against the end surface of the welding finishing-end-side end 12b of the workpiece 12 by the selection of the attachment position of the block member 20 to the workpiece surface plate 4 and the adjustment of the amount of protrusion of the workpiece pressing member 23 from the block member 20 by the positional adjustment member 24. In this state, the welding finishing-end-side end 12b of the workpiece 12 is positioned by the finishing-end-side workpiece stopper 16.

Therefore, the positions of the welding starting-end-side end 12a and the welding finishing-end-side end 12b of the workpiece 12 placed on the workpiece surface plate 4 are secured by the starting-end-side workpiece stopper 15 and the finishing-end-side workpiece stopper 16.

Next, each starting-end-side workpiece clamping mechanism 17 presses a portion, along the welding line 13 in a region close to the welding starting-end-side end 12a of each workpiece 12, against each workpiece surface plate 4 from above to secure the portion, and has the following configuration.

As shown in FIGS. 3A and 3B, the starting-end-side workpiece clamping mechanism 17 includes a turning shaft 31, extending in the upward-downward direction, at a position closer to the upstream side in the friction stir welding traveling direction than each starting-end-side workpiece stopper 15 on the upper surface of each workpiece surface plate 4. A lower end of the turning shaft 31 is rotatably supported by a bearing member 34 provided on the upper surface of the workpiece surface plate 4. An upper end of the turning shaft 31 is rotatably supported by a bearing member 35 provided on a lower surface side of a mount 33 provided on the workpiece surface plate 4 via a strut member 32. As the bearing member 34 that bears the lower end of the turning shaft 31, it may be preferable to use a cross roller bearing in order to receive a thrust load from the lower end of the turning shaft 31.

An arm member 36 that protrudes in a horizontal direction is attached to the outside of the turning shaft 31 so as to turn integrally with the turning shaft 31.

A gear box 38 connected to a motor 37 is installed on an upper side of the mount 33, and an output shaft 38a of the gear box 38 that extends downward through the mount 33 is coupled to the turning shaft 31. Accordingly, by appropriately adjusting a turning direction and a turning angle of the turning shaft 31 through the operation of the motor 37, the arm member 36 attached to the turning shaft 31 can be switched to a use posture where the arm member is disposed above and along an end edge (inner end edge) on the side of the gap 3 between the corresponding workpiece surface plates 4 as shown by a solid line in FIG. 3A, and a withdrawal posture where the arm member is directed to the outside of the workpiece surface plate 4 in the width direction at a turning angle of 90 degrees or more from the use posture as shown by a two-dot chain line in FIG. 3A.

A plurality of hydraulic cylinders 39 are facedown attached to a portion of the arm member 36, which protrudes further to the downstream side in the friction stir welding traveling direction than the starting-end-side workpiece stopper 15 in a state where the arm member is disposed in the use posture, at certain intervals in a longitudinal direction of the arm member 36. FIG. 3A and FIG. 3B show a configuration in which five sets of the hydraulic cylinders 39 are provided in the arm member 36.

In the starting-end-side workpiece clamping mechanism 17 having the above configuration, the arm member 36 is disposed in the use posture and then, the respective hydraulic cylinders 39 are extended, in a state where the workpieces 12 are respectively disposed on the pair of workpiece surface plates 4 and the welding starting-end-side ends 12a of the respective workpieces 12 are positioned. Accordingly, in the starting-end-side workpiece clamping mechanism 17, a tip part of an operating rod 39a of each hydraulic cylinder 39 presses, from above, a portion close to the welding starting-end-side end 12a of each workpiece 12 and in the vicinity of the gap 3, that is, a portion along the welding line 13 between the workpieces 12. Therefore, with this portion being interposed between the operating rod 39a of each hydraulic cylinder 39 and the workpiece surface plate 4, the position of each workpiece 12 can be secured.

Next, the finishing-end-side workpiece clamping mechanism 18 presses a portion, along the welding line 13 in a region close to the welding finishing-end-side end 12b of each workpiece 12, against each workpiece surface plate 4 from above to secure the portion, and has the following configuration.

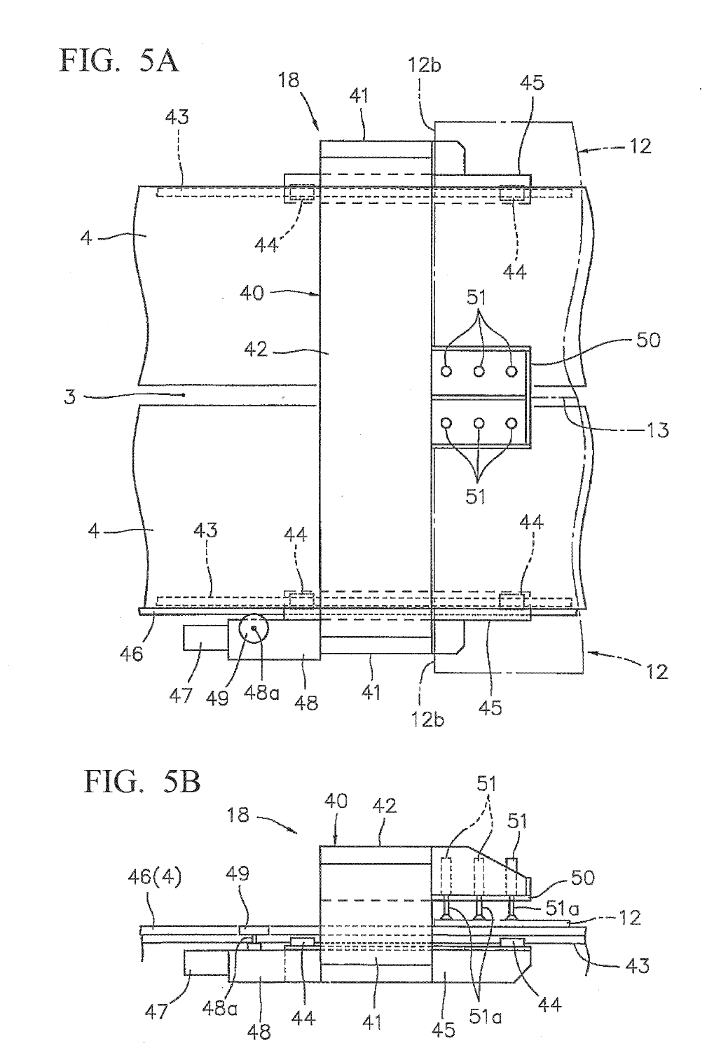

As shown in FIGS. 2, 5A, and 5B, the finishing-end-side workpiece clamping mechanism 18 has a gate type supporting frame 40 including a horizontal part 42 that extends in the horizontal direction orthogonal to the friction stir welding traveling direction so as to straddle the pair of workpiece surface plates 4, and a vertical part 41 that are directly connected to both ends of the horizontal part 42 outside both of the pair of workpiece surface plates 4 that become both ends of the horizontal part 42.

Guide rails 43 that extend along the friction stir welding traveling direction are respectively installed on lower surfaces of both outside end edges of the respective workpiece surface plates 4. A slider 45 is attached to each guide rail 43 via two guide blocks 44, which are disposed with a certain spacing (to be described below) therebetween in the friction stir welding traveling direction, so as to be slidable in the longitudinal direction.

In the supporting frame 40, a lower end of each vertical part 41 is attached to each slider 45.

Moreover, a rack 46 that extends along the friction stir welding traveling direction is attached to an outside (a side opposite to the welding line 13) end surface of a first workpiece surface plate 4. A gear box 48 connected to a motor 47 is attached to one slider 45 corresponding to the rack 46, and a pinion 49 made to mesh with the rack 46 is attached to an output shaft 48a that protrudes upward from the gear box 48. A controller ((not illustrated)) is connected to the motor 47. Accordingly, when a worker ((not illustrated)) operates the controller to control the operation of the motor 47 appropriately, the supporting frame 40 can be moved via a drive mechanism consisting of the rack 46 and the pinion 49 in the upstream-downstream direction in the friction stir welding traveling direction.

A supporting base 50 that protrudes in the horizontal direction above the gap 3 is attached to an upstream surface in the friction stir welding traveling direction at a central part of the supporting frame 40 in the longitudinal direction, and a plurality of hydraulic cylinders 51 are facedown attached to the supporting base 50 at certain intervals in the friction stir welding traveling direction in locations above the end edge of the gap 3 in each workpiece surface plate 4. FIGS. 5A and 5B show a configuration in which three sets of the hydraulic cylinders 51 are provided in two rows in the supporting base 50.

In addition, the spacing between two guide blocks 44 attached to the slider 45 is set such that the supporting frame 40 and the supporting base 50 fall between the two guide blocks 44. As will be described below, this is because the moment generated in the supporting base 50 and the supporting frame 40 is efficiently received by a reaction force caused by the extension of each hydraulic cylinder 51, when each workpiece 12 is secured by the extension of each hydraulic cylinder 51.

In the finishing-end-side workpiece clamping mechanism 18 having the above configuration, the supporting frame 40 is moved such that the supporting base 50 is disposed above a portion close to the welding finishing-end-side end 12b of each workpiece 12 and then, each hydraulic cylinder 51 is extended, in a state where each workpiece 12 is disposed on each workpiece surface plate 4. Accordingly, in the finishing-end-side workpiece clamping mechanism 18, a tip part of an operating rod 51a of each hydraulic cylinder 51 presses, from above, a portion close to the welding finishing-end-side end 12b of each workpiece 12 and in the vicinity of the gap 3, that is, a portion along the welding line 13 between the workpieces 12. Therefore, with this portion being interposed between the operating rod 51a of each hydraulic cylinder 51 and the workpiece surface plate 4, the position of each workpiece 12 can be secured.

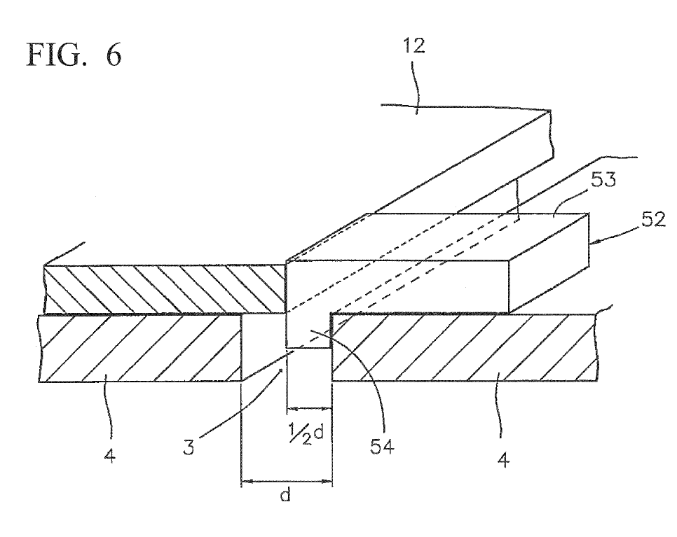

FIG. 6 shows a workpiece alignment jig 52 used to precisely dispose an end of a first workpiece 12 on a welding side, at the center of the gap 3 in the width direction between the workpiece surface plates 4, when the first workpiece 12 is placed on a first workpiece surface plate 4.

In the workpiece alignment jig 52, a vertical part 54 that is bend downward on a first end side of a rectangular parallelepiped-shaped horizontal part 53 extending in the horizontal direction is provided, and a horizontal dimension of the vertical part 54 along the longitudinal direction of the horizontal part 53 is set to half of a width dimension d of the gap 3.

When a first workpiece 12 is placed on a first workpiece surface plate 4, workpiece alignment jigs 52 are disposed in a plurality of locations in the friction stir welding traveling direction, the horizontal part 53 is placed on a second workpiece surface plate 4, and the vertical part 54 is inserted into the gap 3 in advance. In this state, if the end of the first workpiece 12 on the welding side bumps against an end surface of the vertical part 54 of each workpiece alignment jig 52, this end is disposed at a position apart by a distance equivalent to the horizontal dimension of the vertical part 54, that is, half of the width dimension of the gap 3 from the second workpiece surface plate 4. Therefore, by securing the first workpiece 12 to the first workpiece surface plate 4 while maintaining a state where the first workpiece 12 bumps against the vertical part 54 of each workpiece alignment jig 52, the end of the first workpiece 12 serving as an object to be welded is precisely disposed at the center of the gap 3 in the width direction. After the securement of the first workpiece 12 to the first workpiece surface plate 4 is completed as described above, each workpiece alignment jig 52 is detached, and then, the second workpiece 12 placed on the second workpiece surface plate 4 just has to be secured to the workpiece surface plate 4 in a disposition in which the end on the welding side bumps against the first workpiece 12.

In a case where the securement of each workpiece 12 serving as an object to be welded to each workpiece surface plate 4 of the friction stir welding device 1 is performed using the workpiece securing device 14 of the present disclosure, the arm member 36 of each starting-end-side workpiece clamping mechanism 17 is disposed in the withdrawal posture in advance. The finishing-end-side workpiece stopper 16 is detached from the workpiece surface plate 4, and the finishing-end-side workpiece clamping mechanism 18 moves the supporting frame 40 to the end of the workpiece surface plate 4 on the downstream side in the friction stir welding traveling direction to withdraw the supporting frame 40 from a position above the workpiece 12, as shown by the two-dot chain line in FIG. 1. Moreover, in the friction stir welding device 1, as shown in FIG. 1, the welding device body 5 is disposed at the upstream end in the friction stir welding traveling direction, and the friction stir welding tool 6 is also withdrawn so as to not to interfere with each workpiece 12 placed on the workpiece surface plate 4.

In this state, the first workpiece 12 is first carried in and placed on the first workpiece surface plate 4. In this case, the end of the first workpiece 12 on the welding side is disposed at the center of the gap 3 in the width direction using the workpiece alignment jig 52 as described above, and the welding starting-end-side end 12a is disposed to bump against the starting-end-side workpiece stopper 15.

Next, in the first workpiece surface plate 4, the block member 20 of the finishing-end-side workpiece stopper 16 is secured to the tap holes 19, which are located closer to the downstream side in the friction stir welding traveling direction than the welding finishing-end-side end 12b of the first workpiece 12, using the bolts 22.

Next, in the finishing-end-side workpiece stopper 16, the workpiece pressing member 23 is gradually projected to the upstream side in the friction stir welding traveling direction on the basis of the block member 20 by the positional adjustment member 24, and is pressed against the welding finishing-end-side end 12b of the first workpiece 12. Accordingly, the first workpiece 12 placed on the first workpiece surface plate 4 is prevented from being displaced in the upstream-downstream direction in the friction stir welding traveling direction, and the position thereof in this direction is secured.

When the execution of the friction stir welding along the welding line 13 between the workpieces 12 ends, a recess of a shape corresponding to a probe of the friction stir welding tool 6 in the welding finishing-end-side end 12b of each workpiece 12 may remain in a location where the probe is extracted. Therefore, each workpiece 12 may have a configuration in which a tab plate (disposable plate) ((not illustrated)) that extends a welded part in the downstream side in the friction stir welding traveling direction is provided in advance in the welding finishing-end-side end 12b. In each workpiece 12 including the tab plate, the recess which is formed when extracting the probe of the friction stir welding tool 6 is formed in the tab plate. Thus, by excising the tab plate after the end of the execution of the friction stir welding, it is possible to obtain a welded object of the workpieces 12 in which the recess does not remain. In a case where a workpiece 12, in which the tab plate is provided in this type of welding finishing-end-side end 12b, is used as the object to be welded, the finishing-end-side workpiece stopper 16 just has to be pressed against the tab plate.

After the positioning of the first workpiece 12 on the first workpiece surface plate 4 is performed as described above, the arm member 36 of the corresponding first starting-end-side workpiece clamping mechanism 17 is turned from the withdrawal posture to the use posture, and then, each hydraulic cylinder 39 provided in the first arm member 36 is extended. Accordingly, the portion close to the welding starting-end-side end 12a of the first workpiece 12 and in the vicinity of the gap 3 is sandwiched and secured between the operating rod 39a of each hydraulic cylinder 39 of the first starting-end-side workpiece clamping mechanism 17, and the first workpiece surface plate 4.

Thereafter, the second workpiece 12 is carried in and placed on the second workpiece surface plate 4. In this case, the end of the second workpiece 12 on the welding side bumps against the end of the first workpiece 12 on the welding side of which the positioning is already performed on the first workpiece surface plate 4, and is thereby disposed at the center of the gap 3 in the width direction. The welding starting-end-side end 12a of the second workpiece 12 is disposed to bump against the starting-end-side workpiece stopper 15 of the second workpiece surface plate 4.

Next, in the second workpiece surface plate 4, after the positioning of the second workpiece 12 in the upstream-downstream direction in the friction stir welding traveling direction is performed using the finishing-end-side workpiece stopper 16 according to the same procedure as in the case of the first workpiece 12, the securement of the portion close to the welding starting-end-side end 12a and in the vicinity of the gap 3 using the corresponding second starting-end-side workpiece clamping mechanism 17 is performed.

After the securement of the welding starting-end-side end 12a of each workpiece 12 by each starting-end-side workpiece clamping mechanism 17 is performed on each workpiece surface plate 4, the supporting frame 40 of the finishing-end-side workpiece clamping mechanism 18 is moved to the upstream side in the friction stir welding traveling direction. Next, each hydraulic cylinder 51 provided in the supporting base 50 stops at a position above the portion close to the welding finishing-end-side end 12b of each workpiece 12 and in the vicinity of the gap 3.

In this state, each hydraulic cylinder 51 is extended in the finishing-end-side workpiece clamping mechanism 18. Accordingly, the portion close to the welding finishing-end-side end 12b of each workpiece 12 and in the vicinity of the gap 3 is sandwiched and secured between the operating rod 51a of each hydraulic cylinder 51 of the finishing-end-side workpiece clamping mechanism 18, and the corresponding workpiece surface plate 4.

After each workpiece 12 placed on each workpiece surface plate 4 is fixed by the workpiece securing device 14 of the present disclosure as described above, in the friction stir welding device 1, the driving of the friction stir welding tool 6 integral with the main shaft 7 is started by the drive device (not illustrated), and movement of the welding device body 5 to the downstream side in the friction stir welding traveling direction by the moving device 9 is started so as to execute the friction stir welding along the welding line 13 between the respective workpieces 12.

When the probe of the friction stir welding tool 6 is sunk into the welded part of the welding starting-end-side end 12a of each workpiece 12 in the case of the execution of the friction stir welding, generally, two non-welled workpieces 12 show loose behavior. Therefore, the fluctuation of a reaction force in the traveling direction of the friction stir welding tool 6 that each workpiece 12 receives is apt to become violent.

In contrast, in the workpiece securing device 14 of the present disclosure, the portion along the welding line 13 in the vicinity of the gap 3 close to the welding starting-end-side end 12a of each workpiece 12 is firmly secured by each starting-end-side workpiece clamping mechanism 17. Therefore, even when the probe of the friction stir welding tool 6 is sunk in, the relative displacement of the welding starting-end-side ends 12a of the respective workpieces 12 in the upward-downward direction or mutually separating directions is prevented. Moreover, the displacement of each workpiece 12 in a direction along the rotation of the friction stir welding tool 6 is also prevented.

From above, in a case where the workpiece securing device 14 of the present disclosure is used, the quality of friction stir welding between the welding starting-end-side ends 12a of the respective workpieces 12 can be made excellent in the case of the performance of friction stir welding.

When the probe of the friction stir welding tool 6 slips out from the welding finishing-end-side end 12b of each workpiece 12 in the case of the performance of friction stir welding, along with the workpiece 12 disappearing from the periphery of this probe, a phenomenon that resembles cutting without sufficient execution of the friction stir welding occurs. Therefore, generally, vibration is apt to be generated.

In contrast, in the workpiece securing device 14 of the present disclosure, the portion along the welding line 13 in the vicinity of the gap 3 close to the welding finishing-end-side ends 12b of the respective workpieces 12 is firmly secured by the finishing-end-side workpiece clamping mechanism 18. Therefore, even when the probe of the friction stir welding tool 6 slips out, vibration of the welding finishing-end-side end 12b of each workpiece 12 is suppressed.

From above, in a case where the workpiece securing device 14 of the present disclosure is used, the quality of friction stir welding between the welding finishing-end-side ends 12b of the respective workpieces 12 can be made excellent in the case of the performance of friction stir welding.

In addition, the present inventor obtains the following knowledge on the friction stir welding in the process of development of the workpiece securing device 14 of the present disclosure.

As a force that acts on each workpiece 12 at the time of the execution of friction stir welding, a reaction force in a direction in which the friction stir welding tool 6 travels is the greatest. For this reason, if the securement of the welding starting-end-side end 12a and the welding finishing-end-side end 12b of each workpiece 12 to the workpiece surface plate 4 in the upstream-downstream direction in the friction stir welding traveling direction is firm, securement from both sides in the width direction with respect to an intermediate part in the friction stir welding traveling direction is not important.

Moreover, in the workpieces 12 that are objects to be welded, if the friction stir welding tool 6 travels in the friction stir welding traveling direction and is separated by a certain constant distance from the welding starting-end-side end 12a, a welded part welded between the workpieces 12 until then functions as a strength member that constrains displacement of non-welded parts of the respective workpieces 12 located close to the downstream side in the friction stir welding traveling direction. For this reason, in a location where the friction stir welding tool 6 travels after that, the welded part functions as a sequential strength member as mentioned above. Accordingly, relative displacement of the respective workpieces 12 in the mutually separating directions, buckling of the respective workpieces 12 in the upward-downward direction, or rotational displacement of each workpiece 12 in a direction along the rotational direction of the friction stir welding tool 6 is prevented.

On the basis of this knowledge, in the workpiece securing device 14 of the present disclosure, a range where the securement of each workpiece 12 close to the welding starting-end-side end 12a by each starting-end-side workpiece clamping mechanism 17 is performed is set to correspond to the certain constant distance.

Accordingly, in the workpiece securing device 14 of the present disclosure, with respect to the intermediate portion of each workpiece 12 located between the starting-end-side workpiece clamping mechanism 17 and the finishing-end-side workpiece clamping mechanism 18, members that secure the intermediate portion are not separately required, and the quality of friction stir welding of the intermediate portion also become excellent.

Therefore, according to the workpiece securing device 14 of the present disclosure, friction stir welding of excellent quality without deviation between the respective workpieces 12 or buckling thereof is performed on each workpiece 12 over the entire length of the welding line 13 between the respective workpieces 12.

After the friction stir welding over the entire length of the welding line 13 between the workpieces 12 is completed, the respective hydraulic cylinders 39 and 51 are retracted at the respective starting-end-side workpiece clamping mechanism 17 and the finishing-end-side workpiece clamping mechanism 18. Next, in each starting-end-side workpiece clamping mechanism 17, each arm member 36 is turned to the withdrawal posture, and in the finishing-end-side workpiece clamping mechanism 18, the supporting frame 40 is withdrawn to the downstream end of the workpiece surface plate 4 in friction stir welding traveling direction.

Thereafter, in each workpiece surface plate 4, after the securement of the welding finishing-end-side end 12b of each workpiece 12 by each finishing-end-side workpiece stopper 16 is released, each finishing-end-side workpiece stopper 16 is detached, and then, the welded workpieces 12 are carried out from the workpiece surface plate 4.

In this way, the workpiece securing device 14 of the present disclosure does not require to include separate workpiece securing members between each starting-end-side workpiece clamping mechanism 17 and the finishing-end-side workpiece clamping mechanism 18 and does not also require securing members that secure each workpiece 12 from both sides in the width direction. Therefore, even in a case where the workpiece securing device 14 is allowed to cope with welding of the workpieces 12 with a greater width dimension than the workpiece surface plates 4 or welding of the workpieces 12 that are elongated in the friction stir welding traveling direction, the number of the devices to be used for securement of the workpieces 12 can be prevented from increasing.

Hence, the workpiece securing device 14 of the present disclosure can easily secure even a large-sized workpiece 12 to each workpiece surface plate 4.

Moreover, each starting-end-side workpiece clamping mechanism 17 and the finishing-end-side workpiece clamping mechanism 18 are of a movable type, and is allowed to be withdrawn at the time of carrying-in or carrying-out of each workpiece 12 to each workpiece surface plate 4. Therefore, the work of carrying in and carrying out each workpiece 12 to each workpiece surface plate 4 can be further facilitated.

In addition, since each finishing-end-side workpiece stopper 16 is detachable from each workpiece surface plate 4, the easiness of the work of carrying in and carrying out the workpiece 12 to each workpiece surface plate 4 can be further improved.

Moreover, in the finishing-end-side workpiece stopper 16, the workpiece pressing member 23 that can change the amount of protrusion to the upstream side in the friction stir welding traveling direction is provided in the block member 20 attached to the workpiece surface plate 4. Therefore, even if the dimensions of the workpieces 12 that are object to be welded in the friction stir welding traveling direction are not uniform, it is possible to easily cope with the dimensions, and secure the positions of the welding finishing-end-side ends 12b of the workpieces 12.

The present disclosure is not limited only to the above embodiment, and each starting-end-side workpiece stopper 15 is secured to each workpiece surface plate 4. However, the starting-end-side workpiece stopper 15 may be attached so that the position thereof can be changed in the upstream-downstream direction in the friction stir welding traveling direction with respect to the workpiece surface plate 4, similar to each finishing-end-side workpiece stopper 16. In this case, a range where the position of the starting-end-side workpiece stopper 15 can be changed just has to be a range where each hydraulic cylinder 39 provided in the arm member 36 of a corresponding starting-end-side workpiece clamping mechanism 17 reaches the welding starting-end-side end 12a of the workpiece 12 positioned by the starting-end-side workpiece stopper 15.

Although each finishing-end-side workpiece stopper 16 shows a configuration including the workpiece pressing member 23 that makes the amount of protrusion from the block member 20 variable, the finishing-end-side workpiece stopper may have a configuration of only a block-like member detachably attached to each workpiece surface plate 4. In this case, the finishing-end-side workpiece stopper consisting only of this block-like member just has to be separately manufactured whenever the dimension from a position where the welding finishing-end-side end 12b of the workpiece 12 placed on the workpiece surface plate 4 is disposed to an attachment position of the finishing-end-side workpiece stopper itself to the workpiece surface plate 4 is different. Hence, the close contact between a finishing-end-side workpiece stopper 16 actually attached to the workpiece surface plate 4 and the welding finishing-end-side end 12b of the workpiece 12 just has to be adjusted by inserting a gap plate, such as a shim or a spacer appropriately.

The starting-end-side workpiece clamping mechanisms 17 and the finishing-end-side workpiece clamping mechanism 18 show a configuration including the hydraulic cylinders 39 and 51 as pressing members that press the workpieces 12 against the workpiece surface plates 4 from above. However, arbitrary pressing members, such as pneumatic cylinders or electrical cylinders, other than the hydraulic cylinders 39 and 51 may be adopted as long as the pressing members can be operated in the upward-downward direction and can apply pushing forces to the workpieces 12 placed on the workpiece surface plates 4 from above.

If each starting-end-side workpiece clamping mechanism 17 can be withdrawn in a disposition in which there is not interference at the time of the carrying-in or carrying out of each workpiece 12 to each workpiece surface plate 4, the withdrawal structure thereof is not limited to a type in which the starting-end-side workpiece clamping mechanism is turned in the horizontal direction. A type in which the starting-end-side workpiece clamping mechanism is turned in the upward-downward direction, or a type in which the starting-end-side workpiece clamping mechanism travels in the upward-downward direction in the friction stir welding traveling direction similar to the finishing-end-side workpiece clamping mechanism 18 may be adopted.

In a case where a change in the size of each workpiece 12 placed on each workpiece surface plate 4 in the friction stir welding traveling direction is limited to within a range of several meters, the withdrawal structure of the finishing-end-side workpiece clamping mechanism 18 is not limited to a type in which the finishing-end-side workpiece clamping mechanism travels in the upstream-downstream direction in the friction stir welding traveling direction. A type in which the finishing-end-side workpiece clamping mechanism is turned in the horizontal direction similar to each starting-end-side workpiece clamping mechanism 17, and a type in which the finishing-end-side workpiece clamping mechanism is turned in the upward-downward direction may be adopted.

In addition, various changes can be added without departing from the concept of the present disclosure.

### INDUSTRIAL APPLICABILITY

According to the workpiece securing device for a friction stir welding device of the present disclosure, even large-sized workpieces can be easily secured to the workpiece surface plates.

What is claimed is:

1. A workpiece securing device for a friction stir welding device comprising:
a workpiece surface plate on which each of workpieces serving as objects to be welded is to be placed in a state where the workpieces are butted against each other;
a starting-end-side workpiece stopper that positions a welding starting-end-side end where friction stir welding of each workpiece is started, at an upstream end of the workpiece surface plate in a friction stir welding traveling direction;
a starting-end-side workpiece clamping mechanism that presses and secures a portion along a welding line between the workpieces close to the welding starting-end-side end of each workpiece against the workpiece surface plate from above;
a finishing-end-side workpiece stopper that positions a welding finishing-end-side end where the friction stir welding of each workpiece ends, on a downstream side of the workpiece surface plate in the friction stir welding traveling direction; and
a finishing-end-side workpiece clamping mechanism that presses and secures a portion along the welding line between the workpieces close to the welding finishing-end-side end of each workpiece against the workpiece surface plate from above.

2. The workpiece securing device for a friction stir welding device according to claim 1,
wherein the finishing-end-side workpiece stopper is detachably attached to the workpiece surface plate such that the position thereof is changeable in an upstream-downstream direction in the friction stir welding traveling direction.

3. The workpiece securing device for a friction stir welding device according to claim 2,
wherein the finishing-end-side workpiece stopper includes a workpiece pressing member to be pressed against the welding finishing-end-side end of the workpiece such that the position of the workpiece pressing member is changeable in an upstream-downstream direction in the friction stir welding traveling direction.

4. The workpiece securing device for a friction stir welding device according to claim 1,
wherein the starting-end-side workpiece clamping mechanism is switchable between a state where the starting-end-side workpiece clamping mechanism is disposed at a position above the portion along the welding line between the workpieces close to the welding starting-end-side end of the workpiece placed on the workpiece surface plate, and a state where the starting-end-side workpiece clamping mechanism is withdrawn from a position above the workpiece.

5. The workpiece securing device for a friction stir welding device according to claim 1,
wherein the finishing-end-side workpiece clamping mechanism is switchable between a state where the finishing-end-side workpiece clamping mechanism is disposed at a position above the portion along the welding line between the workpieces close to the welding finishing-end-side end of the workpiece placed on the workpiece surface plate, and a state where the finishing-end-side workpiece clamping mechanism is withdrawn from a position above the workpiece.

6. The workpiece securing device for a friction stir welding device according to claim 1,
wherein the finishing-end-side workpiece clamping mechanism is movable with respect to the workpiece surface plate in an upstream-downstream direction in the friction stir welding traveling direction.

7. A method of securing a workpiece for a friction stir welding device comprising:
positioning a first workpiece of a pair of workpieces on a first workpiece surface plate of a pair of workpiece surface plates facing each other with a gap therebetween, in an upstream-downstream direction in a friction stir welding traveling direction and in a width direction of the workpiece surface plate;
pressing and securing a portion close to a welding starting-end-side end of the first workpiece and in the vicinity of the gap against the first workpiece surface plate from above;
positioning a second workpiece of the pair of workpieces on a second workpiece surface plate of the pair of workpiece surface plates, in the upstream-downstream direction in the friction stir welding traveling direction and in the width direction of the first workpiece surface plate;
pressing and securing a portion close to the welding starting-end-side end of the second workpiece and in the vicinity of the gap against the second workpiece surface plate from above; and
pressing and securing portions close to the welding finishing-end-side ends of the pair of workpieces and in the vicinity of the gap against the pair of workpiece surface plates from above.

8. The workpiece securing device for a friction stir welding device according to claim 4,
wherein the finishing-end-side workpiece clamping mechanism is switchable between a state where the finishing-end-side workpiece clamping mechanism is disposed at a position above the portion along the welding line between the workpieces close to the welding finishing-end-side end of the workpiece placed on the workpiece surface plate, and a state where the finishing-end-side workpiece clamping mechanism is withdrawn from a position above the workpiece.

9. The workpiece securing device for a friction stir welding device according to claim 4,
wherein the finishing-end-side workpiece clamping mechanism is movable with respect to the workpiece surface plate in the upstream-downstream direction in the friction stir welding traveling direction.

10. The workpiece securing device for a friction stir welding device according to claim 5,
wherein the finishing-end-side workpiece clamping mechanism is movable with respect to the workpiece surface plate in the upstream-downstream direction in the friction stir welding traveling direction.

11. The workpiece securing device for a friction stir welding device according to claim 2,
wherein the starting-end-side workpiece clamping mechanism is switchable between a state where the starting-end-side workpiece clamping mechanism is disposed at a position above the portion along the welding line between the workpieces close to the welding starting-end-side end of the workpiece placed on the workpiece surface plate, and a state where the starting-end-side workpiece clamping mechanism is withdrawn from a position above the workpiece.

12. The workpiece securing device for a friction stir welding device according to claim 3,
wherein the starting-end-side workpiece clamping mechanism is switchable between a state where the starting-end-side workpiece clamping mechanism is disposed at a position above the portion along the welding line between the workpieces close to the welding starting-end-side end of the workpiece placed on the workpiece surface plate, and a state where the starting-end-side workpiece clamping mechanism is withdrawn from a position above the workpiece.

13. The workpiece securing device for a friction stir welding device according to claim 2,
wherein the finishing-end-side workpiece clamping mechanism is switchable between a state where the finishing-end-side workpiece clamping mechanism is disposed at a position above the portion along the welding line between the workpieces close to the welding finishing-end-side end of the workpiece placed on the workpiece surface plate, and a state where the finishing-end-side workpiece clamping mechanism is withdrawn from a position above the workpiece.

14. The workpiece securing device for a friction stir welding device according to claim 3,
wherein the finishing-end-side workpiece clamping mechanism is switchable between a state where the finishing-end-side workpiece clamping mechanism is disposed at a position above the portion along the welding line between the workpieces close to the welding finishing-end-side end of the workpiece placed on the workpiece surface plate, and a state where the finishing-end-side workpiece clamping mechanism is withdrawn from a position above the workpiece.

15. The workpiece securing device for a friction stir welding device according to claim 2,
wherein the finishing-end-side workpiece clamping mechanism is movable with respect to the workpiece surface plate in an upstream-downstream direction in the friction stir welding traveling direction.

16. The workpiece securing device for a friction stir welding device according to claim 3,
wherein the finishing-end-side workpiece clamping mechanism is movable with respect to the workpiece surface plate in an upstream-downstream direction in the friction stir welding traveling direction.
